(19) United States
(12) Patent Application Publication
(10) Pub. No.: US 2007/0025073 A1
(43) Pub. Date: Feb. 1, 2007

(54) Computing apparatus

(76) Inventor: Shih-Chi Liu, Taipei City (TW)

Correspondence Address: KIRSCHSTEIN, OTTINGER, ISRAEL;& SCHIFFMILLER, P.C., 489 FIFTH AVENUE, NEW YORK, NY, 10017, US

(21) Appl. No.: 11/286,191

(22) Filed: Nov. 22, 2005

(30) Foreign Application Priority Data
Jul. 27, 2005 (TW) 094212744

(51) Int. Cl. G06F 1/16

(52) U.S. Cl. 361/685

(57) ABSTRACT

A computing apparatus includes a housing, a data storage device, an anchor member, and a fastener. The housing confines a compartment and has a mounting wall. The data storage device is disposed in the compartment. The anchor member has a first anchoring portion fastened to the data storage device, and a second anchoring portion that extends transverse to the first anchoring portion and that extends adjacent and parallel to the mounting wall of the housing. The fastener secures removably the second anchoring portion to the mounting wall of the housing.

### CROSS-REFERENCE TO RELATED APPLICATION

This application claims priority of Taiwanese Application No. 094212744, filed on Jul. 27, 2005.

### BACKGROUND OF THE INVENTION

1. Field of the Invention

The invention relates to a computing apparatus, more particularly to a computing apparatus that has an anchor member for securing removably a data storage device in a housing.

2. Description of the Related Art

A conventional computing apparatus includes a housing, a data storage device disposed in the housing, first and second screw fasteners, and a positioning frame for securing the data storage device in the housing. To assemble the conventional computing apparatus, the positioning frame is first sleeved on the data storage device, and the first screw fasteners extend through the positioning frame and engage threadedly the data storage device. The positioning frame, along with the data storage device, is then disposed in the housing, and the second screw fasteners extend through the housing and engage threadedly the positioning frame, such that the data storage device is securely disposed in the housing.

When it is required to repair or replace the data storage device, the same needs to be taken out of the housing. However, since the aforesaid assembly procedure for the conventional computing apparatus is relatively complex, it is troublesome to dismantle the data storage device from the housing. In particular, in view of the limited space in the housing, it is not possible to remove the data storage device from the positioning frame without first removing the positioning frame from the housing.

### SUMMARY OF THE INVENTION

Therefore, the object of the present invention is to provide a computing apparatus having a data storage device and a housing that can be easily assembled together and dismantled from each other.

According to the present invention, there is provided a computing apparatus that includes a housing, a data storage device, an anchor member, and a fastener. The housing confines a compartment and has a mounting wall. The data storage device is disposed in the compartment. The anchor member has a first anchoring portion fastened to the data storage device, and a second anchoring portion that extends transverse to the first anchoring portion and that extends adjacent and parallel to the mounting wall of the housing. The fastener secures removably the second anchoring portion to the mounting wall of the housing.

### BRIEF DESCRIPTION OF THE DRAWINGS

Other features and advantages of the present invention will become apparent in the following detailed description of the preferred embodiments with reference to the accompanying drawings, of which:

FIG. 1 is a partly exploded, perspective view of the first preferred embodiment of a computing apparatus according to the present invention;

FIG. 2 is a fragmentary schematic side view of the first preferred embodiment, illustrating an anchor member fastened to a data storage device;

FIG. 3 is a fragmentary schematic sectional view of the first preferred embodiment;

FIG. 4 is an enlarged fragmentary schematic sectional view of the first preferred embodiment; and

FIG. 5 is an enlarged fragmentary schematic sectional view of the second preferred embodiment of a computing apparatus according to the present invention.

### DETAILED DESCRIPTION OF THE PREFERRED EMBODIMENTS

Before the present invention is described in greater detail, it should be noted herein that like elements are denoted by the same reference numerals throughout the disclosure.

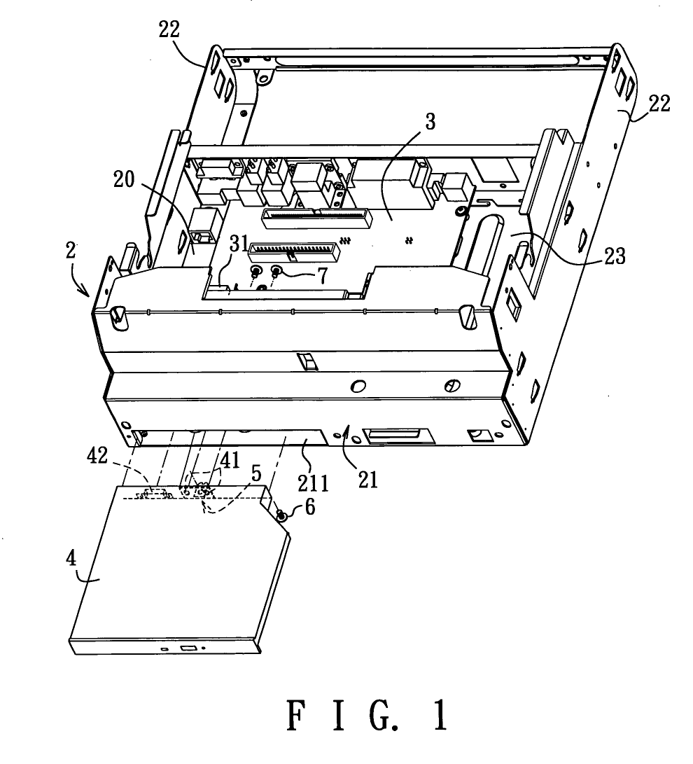

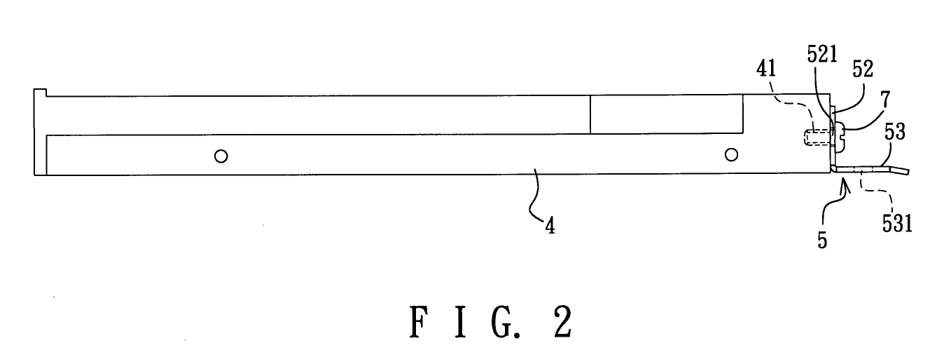

As shown in FIG. 1 and FIG. 2, the first preferred embodiment of a computing apparatus according to the present invention includes a housing 2, a mother board 3, a data storage device 4, an anchor member 5, and first and second fasteners 6, 7.

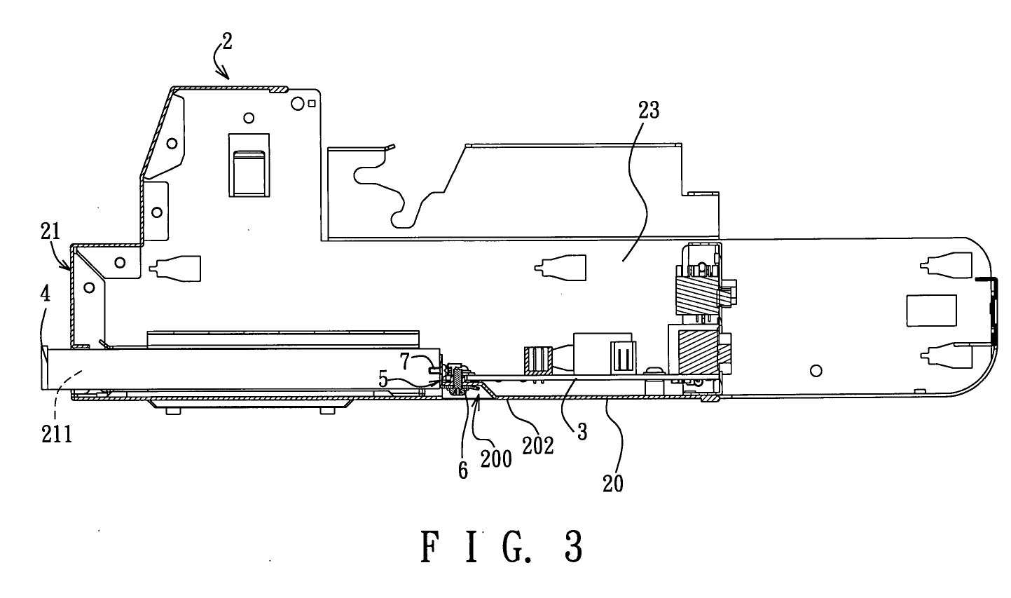

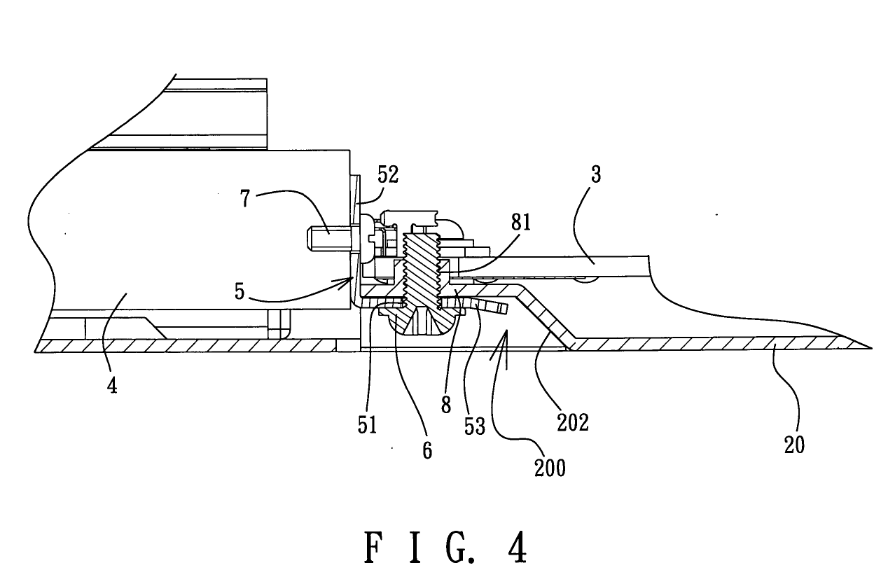

The housing 2 confines a compartment 23, and has a mounting wall 20, which is a bottom wall in this embodiment, and a front wall 21 formed with an opening 211 for access into the compartment 23. As shown in FIG. 3 and FIG. 4, in this embodiment, the mounting wall 20 of the housing 2 has an outer wall surface 202, and is punched from the outer wall surface 202 to form a securing tab 8 that projects into the compartment 23 and to configure the outer wall surface 202 with a trench 200 that is in spatial communication with the compartment 23.

The motherboard 3 is disposed in the compartment 23 of the housing 2, and has a device-engaging interface 31.

The data storage device 4, which is an optical disc drive in this embodiment, is inserted into the compartment 23 of the housing 2 through the opening 211 in the front wall 21 of the housing 2. The data storage device 4 has a motherboard-engaging interface 42 corresponding to the device-engaging interface 31 of the motherboard 3, such that when the data storage device 4 is disposed in the compartment 23, the motherboard-engaging interface 42 is connected directly to the device-engaging interface 31.

The anchor member 5 is L-shaped, and has first and second anchoring portions 52, 53. The first anchoring portion 52 is fastened to the data storage device 4. The second anchoring portion 53 extends transverse to the first anchoring portion 52, and extends adjacent and parallel to the mounting wall 20 of the housing 2. In this embodiment, the second anchoring portion 53 extends from the compartment 23 of the housing 2 into the trench 200 in the outer wall surface 202 of the mounting wall 20, and abuts against the securing tab 8, as best illustrated in FIG. 4.

The first and second fasteners 6, 7 secure removably the second anchoring portion 53 to the mounting wall 20 of the housing 2, and the first anchoring portion 52 to the data storage device 4, respectively.

As shown in FIG. 1 and FIG. 2, in this embodiment, the data storage device 4 is formed with two screw holes 41, and the first anchoring portion 52 of the anchor member 5 is formed with two first through holes 521. The second fastener 7 includes two screws that extend through the first through holes 521 in the first anchoring portion 52, and that engage threadedly the screw holes 41 in the data storage device 4, respectively. As shown in FIG. 4, the securing tab 8 of the mounting wall 20 of the housing 2 is formed with a screw hole 81, and the second anchoring portion 53 of the anchor member 5 is formed with a second through hole 531. The first fastener 6 is a screw that extends through the second through hole 531 in the second anchoring portion 53 of the anchor member 5 and that engages threadedly the screw hole 81 in the securing tab 8 of the mounting wall 20.

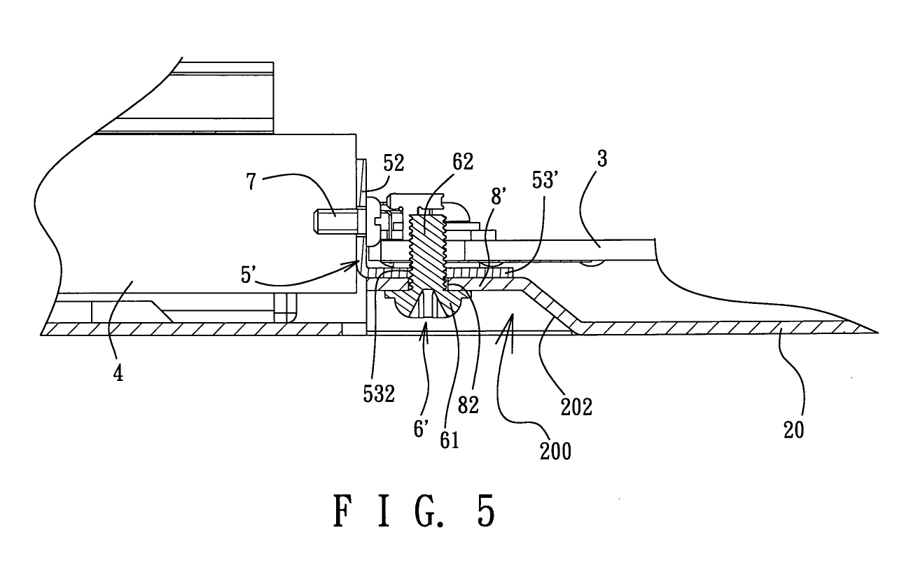

As shown in FIG. 5, the second preferred embodiment of a computing apparatus according to the present invention differs from the first preferred embodiment in the way the second anchoring portion 53′ of the anchor member 5′ is secured removably to the mounting wall 20 of the housing 2.

In this embodiment, the securing tab 8′ of the mounting wall 20 is formed with a through hole 82, instead of the screw hole 81 in the first preferred embodiment. Unlike the first preferred embodiment, the second anchoring portion 53′ of the anchor member 5′ does not extend into the trench 200 in the outer wall surface 202 of the mounting wall 20 of the housing 2. Instead, the second anchoring portion 53′ is disposed in the compartment 23 of the housing 2 and abuts against the securing tab 8′. The second anchoring portion 53′ is formed with a screw hole 532, instead of the through hole 531 in the first preferred embodiment. The first fastener 6′ has ahead portion 61 that is disposed in the trench 200 and that abuts against the securing tab 81′, and a shank portion 62 that extends through the through hole 82 in the securing tab 8′ and that engages threadedly the screw hole 532 in the second anchoring portion 53′ of the anchor member 5′.

It should be noted herein that it is not necessary for the trench 200 of the housing 2 to be in spatial communication with the compartment 23 in this embodiment since the second anchoring portion 53′ is not required to extend into the trench 200.

Since the mounting wall 20 is the bottom wall in these preferred embodiments, the securing tab 8 (8′) needs to be formed on the outer wall surface 202 of the mounting wall 20 and to project into the compartment 23, such that the first fastener 6 (6′) would not obstruct placing of the computing apparatus on a flat surface, such as a surface of a desk. However, when the mounting wall 20 is a side wall 22 (refer to FIG. 1) of the housing 2, the first fastener 6 would not impede placing of the computing apparatus on the flat surface even without the presence of the securing tab 8. In other words, the securing tab 8 is not a necessary component in other embodiments of the present invention.

Unlike the conventional computing apparatus, according to the present invention, the data storage device 4 can be taken out of the housing 2 for repair or replacement simply by unfastening the first fastener 6 (6′) from the second anchoring portion 53 (53′) of the anchor member 5 (5′) or the mounting wall 20 of the housing 2, and subsequently uprooting the data storage device 4 from the compartment 23 through the opening 211, such that the motherboard-engaging interface 42 of the data storage device 4 and the device-engaging interface 31 of the motherboard 3 are disconnected from each other. Therefore, the data storage device 4 and the housing 2 of the computing apparatus according to the present invention can be easily assembled together and dismantled from each other.

While the present invention has been described in connection with what is considered the most practical and preferred embodiments, it is understood that this invention is not limited to the disclosed embodiments but is intended to cover various arrangements included within the spirit and scope of the broadest interpretation and equivalent arrangements.

What is claimed is:

1. A computing apparatus comprising:
a housing confining a compartment and having a mounting wall;
a data storage device disposed in said compartment;
an anchor member having a first anchoring portion fastened to said data storage device, and a second anchoring portion that extends transverse to said first anchoring portion and that extends adjacent and parallel to said mounting wall of said housing; and
a first fastener for securing removably said second anchoring portion to said mounting wall of said housing.

2. The computing apparatus as claimed in claim 1, wherein said data storage device is an optical disc drive.

3. The computing apparatus as claimed in claim 1, further comprising a second fastener for fastening removably said first anchoring portion to said data storage device.

4. The computing apparatus as claimed in claim 3, wherein said second fastener is a screw that extends through said first anchoring portion of said anchor member and that engages threadedly said data storage device.

5. The computing apparatus as claimed in claim 1, wherein:
said mounting wall has an outer wall surface, and is punched from said outer wall surface to form a securing tab that projects into said compartment and to configure said outer wall surface with a trench that is in spatial communication with said compartment;
said second anchoring portion of said anchor member extends into said trench and abuts against said securing tab; and
said first fastener is a screw that extends through said second anchoring portion of said anchor member and that engages threadedly said securing tab of said mounting wall.

6. The computing apparatus as claimed in claim 1, wherein said first fastener is a screw that extends through said mounting wall and that engages threadedly said second anchoring portion of said anchor member.

7. The computing apparatus as claimed in claim 6, wherein:
said mounting wall has an outer wall surface, and is punched from said outer wall surface to form a securing tab that projects into said compartment and to configure said outer wall surface with a trench; and
said first fastener has a head portion that is disposed in said trench and that abuts against said securing tab, and a shank portion that extends from said head portion and through said second securing tab and that engages threadedly said second anchoring portion of said anchor member.
